(19) United States
(12) Patent Application Publication
(10) Pub. No.: US 2025/0362652 A1
(43) Pub. Date: Nov. 27, 2025

(54) Method and System for Providing Control Applications

(71) Applicant: Siemens Aktiengesellschaft, Muenchen (DE)

(72) Inventors: Christian Peter FEIST, München (DE); Christian KNIERIM, München (DE); Harald ALBRECHT, Nürnberg (DE)

(21) Appl. No.: 18/871,935

(22) PCT Filed: May 5, 2023
(86) PCT No.: PCT/EP2023/061952

§ 371 Date: Dec. 5, 2024

(30) Foreign Application Priority Data
Jun. 8, 2022 (EP) 22177736

(51) Int. Cl. G05B 15/02

(52) U.S. Cl. CPC G05B 15/02

(57) ABSTRACT

System and method for providing control applications via sequence control components, in the case of control applications of which the execution demands selected privileges, wherein a specification of each of the required safety-critical resources is established, an additional sequence control component, which is provided for providing access to each of the required safety-critical resources, is determined based on the the specifications, execution of the respective sequence control component together with the additional sequence control component is accordingly started, an interface for interprocess communication between the respective sequence control component and the additional sequence control component is set up via a sequence control environment, and the access to the respectively required safety-critical resources is provided via the interprocess communication between the respective sequence control component and the additional sequence control component.

### CROSS-REFERENCE TO RELATED APPLICATIONS

This is a U.S. national stage of application No. PCT/EP2023/061952 filed 2 May 2023. Priority is claimed on European Application No. 22177736.0 filed 8 Jun. 2022, the content of which is incorporated herein by reference in its entirety.

### BACKGROUND OF THE INVENTION

### 1. Field of the Invention

The present invention relates to industrial automation systems and, more particularly, to a system and method for providing control applications, in particular control applications for an industrial automation system.

### 2. Description of the Related Art

Industrial automation systems usually comprise a multiplicity of automation devices, these being interconnected via an industrial communication network, and are used in the context of manufacturing and process automation for open-loop or closed-loop control of sites, machines and/or devices. Due to time-critical framework conditions in industrial automation systems, use is predominantly made of real-time communication protocols, such as PROFINET, PROFIBUS, real-time Ethernet or time-sensitive networking (TSN) to communicate between automation devices. In particular, control services or applications can be distributed in an automated and load-dependent manner over currently available servers or virtual machines of an industrial automation system.

Interruptions of communication connections between computer units of an industrial automation system or automation devices can result in an undesired or unnecessary repetition of a transmission of a service request. In addition, messages that are not transmitted or not transmitted completely can, for example, prevent an industrial automation system from transitioning into or remaining in a safe operating state.

WO 2022/042905 A1 relates to a method for providing time-critical services, each of which is assigned at least one server component in the form of a sequence control component that can be loaded into a sequence control environment and executed there. A function unit for processing a communication protocol stack is provided for each of the server components and is connected to a further function unit, assigned to the sequence control environment, for processing a communication protocol stack. The services each comprise a directory service component for determining services that are provided by the sequence control environment. The directory service components are interconnected via a separate communication interface. Connected to the separate communication interface is a further sequence control component in the form of an aggregator component, whereby details of the services provided by the server components are made available outside the sequence control environment.

European patent application number 21212849.0 describes a method for providing control applications, where the control applications are each provided via sequence control components that can be loaded into a sequence control environment in the form of a server entity and executed therein. Control applications that demand selected security authorizations are each assigned an identification code as a security-critical control application. For each of those control applications assigned an identification code as a security-critical control application, at least one sequence condition for the selected security authorizations is specified. The sequence control environment monitors any occurrence of the respective sequence condition during the execution of the sequence control components for the control applications. The execution of the sequence control components is always terminated if the respective sequence condition occurs.

US Pub. No. 2019/182295 A1 relates to distribution and management of services in virtual environments. System services and applications are distributed over a plurality of containers, which execute in separate runtime environments both for services and for applications using the services. In particular, provision is made for a service control manager in order to allow communication between a client stub within a client runtime environment and a service within a service runtime environment.

EP 3 937 039 A1 discloses a method for extended validation of a container image, comprising a basic image and at least one application layer that executes at least one change operation on the basic image. Initially, a unique cryptographic basic signature for the basic image is generated by an apparatus of a producer of the basic image. The basic signature is provided to a container generating apparatus. Further to this, a container image is generated in the container generating apparatus, where the container image comprises at least the basic image and the basic signature. The container image is provided to a guest computer, and the basic signature in the container image is checked by a runtime environment of the guest computer. The container image only executes if a check of the basic signature gives a positive check result.

As a result of the functional embodiment of industrial automation devices becoming increasingly flexible, greater use is being made of dynamically loadable control applications in automation devices. These control applications can be made available via container virtualization, for example. In particular, control applications for the analysis of data traffic within an industrial automation system, or for the analysis of control processes running in automation devices, require far-reaching privileges and/or security authorizations. Without additional protective measures, any compromising of such a control application can result in serious security risks, at least for the industrial automation device on which a compromised control application is installed. For this reason, transparent and supervised use of increased privileges for control applications is crucially important.

When granting increased privileges to control applications, it is problematic that the intended purpose of the requested increased privileges is often unclear. In particular, any supervision of compliance with device-related security policies is made considerably more difficult as a result of this. Furthermore, a compromised control application could misuse increased privileges for a purpose for which the control application was not even originally intended. In addition, privileges of a control application are usually linked to the lifecycle thereof. This demands continuous management of access authorizations that have been granted to control applications for security-critical interfaces. Such management of access authorizations is however resource-intensive and susceptible to error.

### SUMMARY OF THE INVENTION

In view of the foregoing, it is therefore an object of the present invention to provide and system and a method for providing control applications that demand extensive security authorizations, where the method ensures that privileges for the control applications are granted in a clear and needs-based manner.

These and other objects and advantages are is inventively achieved by a system and a method for providing control applications, where the control applications are each provided via sequence control components, which can be loaded into a sequence control environment formed by a server entity and executed therein. In particular, the sequence control components can be or comprise software containers that execute within the sequence control environment on a host operating system of a server entity, which are each isolated from other software containers or container groups, for example, pods. As a rule, alternative micro-virtualization systems, such as snaps, can also be used for the sequence control components. The software containers each preferably use a shared kernel of the host operating system of the server entity, jointly with other software containers executing on the respective server entity. Memory images for the software containers can be retrieved, for example, from a memory and provisioning system to which a multiplicity of users have read and/or write access.

In particular, the sequence control environment can be a container runtime environment or container engine via which virtual resources are created, deleted or linked. The virtual resources, in this case, comprise software containers, virtual communication networks and connections assigned thereto. For example, the sequence control environment can comprise a docker engine or a snap core that executes on a server entity. As a rule, other (orchestrated) container runtime environments, such as Podman or Kubernetes can also be used.

For control applications whose execution demands selected privileges, a specification of each required security-critical resource is established. An additional sequence control component is determined based on each of the specifications and is used to provide access to the required security-critical resources. The additional sequence control component that has been determined is loaded into the sequence control environment, and execution of both the respective sequence control component and the additional sequence control component is started.

In addition, the sequence control environment inventively sets up an interface for interprocess communication between the respective sequence control component and the additional sequence control component. Accordingly, the access to the security-critical resources that are each required is provided via the interprocess communication between the respective sequence control component and the additional sequence control component.

By virtue of the present invention, control applications can be granted access to security-critical functions, interfaces and/or resources reliably, accurately and efficiently by providing at least one additional appropriate sequence control component in each case. An additional dedicated sequence control component can generally be provided for each security-critical function, interface or resource. As a result of using additional sequence control components, there is in particular no need for a complicated yet conventional identification of an application programming interface (API) caller or of a computing process assigned to the respective control application.

Furthermore, the present invention has the advantage, compared to token-based approaches for granting increased privileges, that it is not easily possible for access permissions granted by the additional sequence control component to be determined by other system components or by potential attackers. By contrast, an application with far-reaching read permissions can very easily read out and make improper use of access tokens. The additional sequence control component advantageously monitors whether the access to the currently required security-critical resources is requested or provided in compliance with a security policy that must be applied for the respective sequence control component or for a respective host.

In accordance with the invention, the specifications are each established as part of configuration information for the respective sequence control component. The configuration information comprises in each case at least a designation of a memory image for the respective sequence control component and application-specific entries. The configuration information is used in each case to load and/or execute the respective sequence control component. The configuration information can be deployment information for control applications, such as docker-compose.yml configuration files. In this way, access permissions required by control applications to security-critical functions, interfaces and/or resources can be made transparent as part of the respective deployment information.

In accordance with a further embodiment of the present invention, the configuration information for each of the sequence control components is extended as appropriate for the respective specification. The configuration information is preferably evaluated by a management component assigned to the sequence control environment and extended in accordance with the specifications. Here, the sequence control environment only accepts those extensions to the configuration information that are made by the management component, while configuration information that has been extended by other methods is rejected by the sequence control environment. It is consequently possible to effectively ensure that security-critical resources and/or interfaces can only be used in the intended manner.

The specifications of the each of the required security-critical resources can additionally be checked against a device-specific security policy by the management component. The configuration information for the respective sequence control component is adapted by the management component as a function of the check result. In this way, use of security-critical resources can be precisely supervised by applying a device-specific security policy while allowing for individual framework conditions.

A security policy is usually a technical or organizational document, via which security demands in companies or institutions are to be implemented and satisfied. Core components comprise in particular ensuring the integrity, confidentiality, availability and authenticity of information that must be protected. A security policy for a datagram filter component or for a firewall defines, for example, how an actual configuration occurs, which access permissions are granted, how logging occurs or which defensive measures the datagram filter component or firewall takes in an attack scenario. A security policy may be present in particular as a configuration file, an XML file or a device configuration, which can be directly evaluated automatically. Equally, a security policy may be present in a textual format that is evaluated via methods based on artificial intelligence or machine learning. A security policy can also be present in a graphical format which is evaluated via image processing or pattern recognition methods.

The additional sequence control component preferably monitors and controls the access by the respective sequence control component to the security-critical resources that are each required, with reference to a security policy that must be applied for the respective sequence control component. In particular, it is possible thereby to determine precisely which privileged operations a control application actually implements. The security policy can easily and reliably be derived by the additional sequence control component or by a management component assigned to the sequence control environment from the specification of the required security-critical resources in each case, for example. Furthermore, the security policy can be adapted during the execution of the respective sequence control component in an event-dependent manner or as a function of an administrator intervention. It is consequently possible to control the use of security-critical resources even more precisely.

In accordance with a particularly preferred embodiment of the present invention, a plurality of additional sequence control components are preinstalled on a host on whose operating system the sequence control environment is installed. It is thus possible to significantly simplify management of the access, for the control applications, to each of the security-critical resources that are required. In particular, a preinstalled additional sequence control component can easily and reliably be linked to a lifecycle of the sequence control component of the respective control application. Moreover, separate management of the additional sequence control component and the respective sequence control component is then no longer required. Separate management is usually both susceptible to error and complex.

The interface for interprocess communication between the respective sequence control component and the additional sequence control component is advantageously provided by the operating system of the host. By contrast, the additional sequence control component preferably accesses the security-critical resources that are required for the respective sequence control component via a host interprocess communication interface. Particularly secure control of the access to the security-critical resources is ensured thereby.

The inventive system for providing control applications is configured to perform the method as described above and comprises a sequence control environment in the form of a server entity and at least one sequence control component for providing a control application. Here, the sequence control component can be loaded into the sequence control environment and executed therein. The system is set up such that a specification of required security-critical resources is established for each of the control applications whose execution demands selected privileges. Furthermore, the system is set up such that, based on each of the specifications, an additional sequence control component is determined for the purpose of providing access to the required security-critical resources.

The sequence control environment of the inventive system is set up to load the additional sequence control component that has been determined into the sequence control environment, to initiate execution of both the respective sequence control component and the additional sequence control component, and to set up an interface for interprocess communication between the respective sequence control component and the additional sequence control component. Furthermore, the system is set up such that the access to each of the required security-critical resources is provided via interprocess communication between the respective sequence control component and the additional sequence control component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in greater detail below with reference to an exemplary embodiment and to the drawing, in which:

FIG. 1 shows a system for providing control applications which demand selected security authorizations in accordance with the invention; and

FIG. 2 shows an illustration of a method sequence for providing control applications via the system illustrated in FIG. 1.

### DETAILED DESCRIPTION OF THE EXEMPLARY EMBODIMENTS

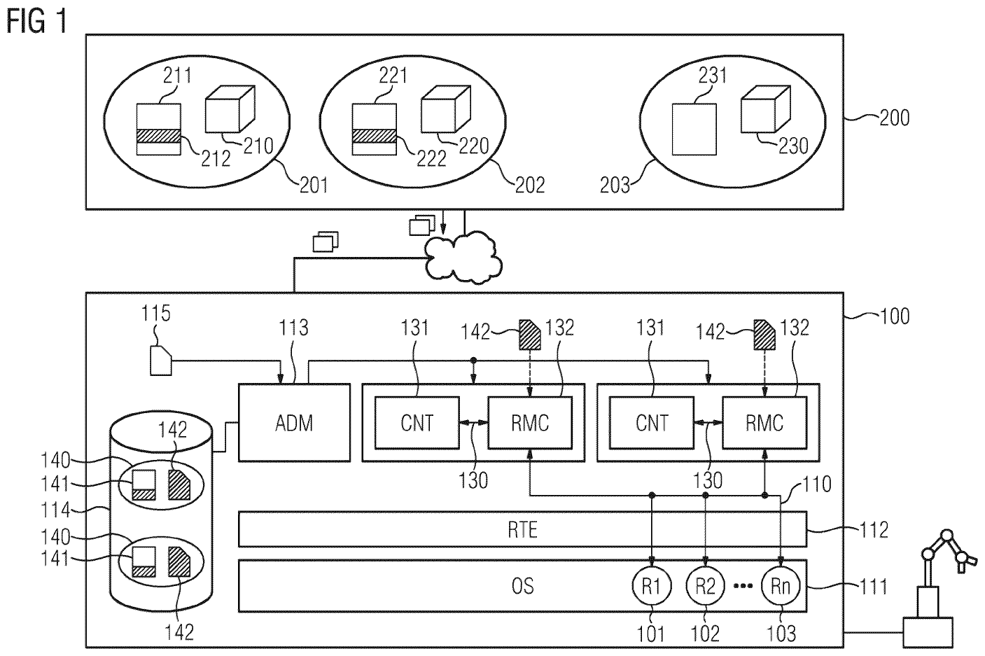

The system illustrated in FIG. 1 comprises a host 100 for providing control applications of an industrial automation system via sequence control components 131, which are implemented by software containers in the present exemplary embodiment. The control applications of the industrial automation system exemplify time-critical services and can also comprise monitoring functions.

With the control applications, the host 100 can implement, for example, functions of control devices in an industrial automation system, such as programmable logic controllers (PLCs), or of field devices such as sensors or actuators. In this way, the host 100 can be used in particular for the purpose of exchanging control variables and measured variables with machines or apparatuses that are controlled by the host 100. Here, the host 100 can determine suitable control variables for the machines or apparatuses from measured variables that have been captured.

Alternatively or additionally, via the control applications, the host 100 can implement functions of an operating and observation station, and can therefore be used to visualize process data or measured variables and control variables, which are processed or captured by automation devices. In particular, the host 100 can be used to display values of a closed-loop control circuit and to change closed-loop control parameters or programs.

In addition, the system illustrated in FIG. 1 comprises a management system 200, via which application packages 201, 202, 203 for control applications are provided. The application packages 201, 202, 203 each comprise at least a memory image 210, 220, 230 for a software container together with associated configuration information 211, 221, 231, and are provided for the host 100 in particular. The configuration information can be deployment information, for example, docker-compose.yml configuration files. In particular, the configuration information 211, 221, 231 each comprise at least a designation of a memory image for the respective software container and application-specific entries. The configuration information 211, 221, 231 is used to load and execute each respective software container.

For control applications whose execution demands selected privileges, the each configuration information 211, 221 comprises a specification 212, 222 of the security-critical resources 101, 102, 103 that are required. By way of example, the following extract from a docker-compose.yml configuration file shows a specification of a read-only access to a docker socket using labels or key-value pairs which are highlighted in bold in the following extract:

```
services:
  my-app-service:
    image: my-app-image:latest
      build:
        context: .
      labels:
          - “com.my-app-service.description=My service
app”
          - “com.my-app-service.host-interfaces.docker-
socket-mode=read-only”
          - “com.my-app-service.host-interfaces.docker-
socket-endpoints=containers”
...
```

A sequence control environment 112 is installed as an operating system application on an operating system 111 of the host 100. The software containers and sequence control components 131 can be loaded into the sequence control environment 112 and executed therein. As a rule, sequence control components 131 can each be migrated from the host 100 onto another host for execution therein or executed concurrently on other hosts.

In the present exemplary embodiment, the software containers each execute isolated from other software containers, container groups or pods within the sequence control environment 112 on the operating system 111 of the host 100. Here, the software containers each use one or the same kernel of the operating system 111, jointly with other software containers executing on the host 100. The sequence control environment 112 is preferably a container runtime environment or a container engine.

An isolation of the software containers or isolation of selected operating system resources from each other can be realized in particular via control groups and namespaces. Control groups make it possible to define process groups in order to limit available resources for selected groups.

Namespaces allow individual processes or control groups to be isolated or concealed from other processes or control groups, because resources of the operating system kernel are virtualized.

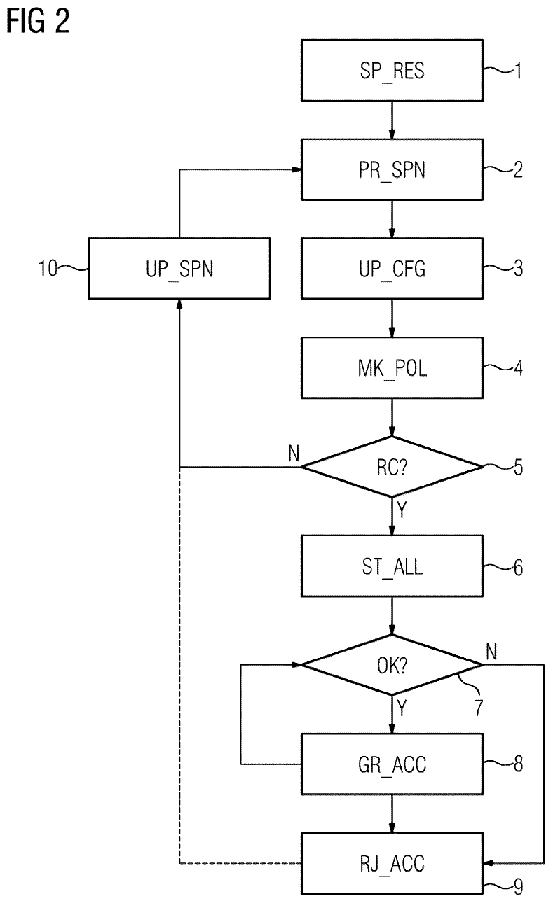

For the purpose of providing control applications that demand selected security authorizations, in accordance with step 1 of the method sequence illustrated in FIG. 2, a specification 212, 222 of each of the required security-critical resources 101, 102, 103 is established as part of the configuration information 211, 221 for these control applications. The configuration information 211, 221 is evaluated by a management component 113 that is assigned to the sequence control environment 112 (step 2), and extended in accordance with specifications 212, 222 that are present (step 3). Here, the specifications 212, 222 of the required security-critical resources 101-103 are also each checked by the management component 113 in this exemplary embodiment against a device-specific, cryptographically protected security policy 115. The management component 113 adapts the configuration information 211, 221 for the respective sequence control component 131 as a function of the check result.

The management component 113 preferably stores the extended and adapted configuration information 141 in a local memory 114 with application data 140. In addition to the adapted configuration information 141, this application data 140 also comprises a security policy 142 which must be applied to the monitoring and control of the access to each of the security-critical resources 101, 102, 103 for the respective sequence control component 131. In the present exemplary embodiment, in accordance with step 4 of the method sequence illustrated in FIG. 2, the security policies 142 are derived from the respective specification 212, 222 of the required security-critical resources 101, 102, 103 by the management component 113 and are advantageously cryptographically protected.

The following extract from a docker-compose.yml configuration file shows adaptations made by the management component 113 in comparison with the previous extract, where the adaptations are highlighted in bold in the following extract:

| services: | |
|---|---|
| my-app-service: | |
| image: my-app-image:latest | |
| build: | |
| context: . | |
| labels: | |
| | - “com.my-app-service.description=My service |
| app” | |
| | - “com.my-app-service.host-interfaces.docker- |
| socket-mode=read-only” | |
| | - “com.my-app-service.host-interfaces.docker- |
| socket-endpoints=containers” | |
| volumes: | |
| - | type: bind |
| | source: /var/lib/docker/edge-iot-core/my- |
| app/proxy-socket.sock | |
| | target: /var/run/docker.sock |
| ... | |
| docker-socket-sidecar-proxy: | |
| image: docker-socket-sidecar:latest | |
| volumes: | |
| - | type: bind |
| | source: /var/lib/docker/edge-iot-core/my- |
| app/socket-policy.json | |
| | target: /var/run/socket-policy.json |
| - | type: bind |
| | source: /var/lib/docker/edge-iot-core/my- |
| app/proxy-socket.sock | |
| | target: /var/run/proxy-socket.sock |
| - | type: bind |
| | source: /var/run/docker.sock |
| | target: /var/ run/docker.sock |

...

The foregoing example for configuration information 141 as adapted by the management component 113 shows an added service (docker-socket-sidecar-proxy) which has access to an application-specific security policy 142 (socket-policy.json) derived and generated by the management component 113, to a local interprocess communication interface (Unix domain socket proxy-socket.sock), and to a host interprocess communication interface (API socket from docker daemon docker.sock). For the software container (my-app-service) of the control application itself, only access to the local interprocess communication interface is granted.

According to existing service mesh solutions such as Istio, a sidecar container is connected before a workload container, and routes to the workload container are redirected via the sidecar container via IPtables, for example. By contrast, in the present exemplary embodiment, each individual software container is provided with a dedicated interprocess communication interface, such as a Unix domain socket, a dedicated network interface, or a dedicated shared memory segment. In particular, in the present exemplary embodiment, there is no sharing of a network namespace and no operating on the same network interface.

Specification of privileges can be implemented via key-value pairs in the form of labels, as per the example above. As an alternative, it is also possible to use a dedicated manifest file, provide an API, or provide setting options for a user. In this way, the user can adapt the privileges even after installation of a control application.

The sequence control environment 112 is preferably configured such that it only accepts adaptations of the configuration information 211, 221 made by the management component 113. Configuration information that has been adapted in other ways is rejected by the sequence control environment 112.

Based on the specifications 212, 222 or based on the adapted configuration information 141, an additional sequence control component 132 is determined in step 5 of the method sequence illustrated in FIG. 2, where the additional sequence control component 132 is preinstalled on the host 100 and is configured to provide the access to the required security-critical resources 101, 102, 103. If a suitable additional sequence control component 132 cannot be determined from a plurality of additional sequence control components that are preinstalled on the host 100, then an adaptation of the specifications 212, 222 and a renewed evaluation (step 2) of the configuration information 211, 221 is effected by the management component 113 in step 10 of the present exemplary embodiment. Alternatively, execution of the respective control application can be terminated if a requested resource cannot be provided in a secure manner.

In step 6 of the method sequence illustrated in FIG. 2, the additional sequence control component 132 that has been determined is loaded into the sequence control environment 112, and an execution of both the respective sequence control component 131 and the additional sequence control component 132 is started. Here, the sequence control environment 112 sets up an interface 130 for interprocess communication between the respective sequence control component 131 and the additional sequence control component 132. The access to the security-critical resources 101, 102, 103 that are each required is provided via interprocess communication between the respective sequence control component 131 and the additional sequence control component 132.

The interface 130 for interprocess communication between the respective sequence control component 131 and the additional sequence control component 132 is provided by the operating system 111 of the host 100 in the present exemplary embodiment. However, the additional sequence control component 132 accesses the security-critical resources 101, 102, 103 that are required for the respective sequence control component 131 via a host interprocess communication interface 110. If this is a system file, then the additional sequence control component 132 can access such a resource directly.

In step 7 of the method sequence illustrated in FIG. 2, the additional sequence control component 132 monitors and controls the access to the currently required security-critical resources 101, 102, 103 by the respective sequence control component 131 in accordance with the security policy 142 that must be applied for the respective sequence control component 131. Access to the security-critical resources 101, 102, 103 is granted (step 8) or rejected (step 9) accordingly. Here, the security policies 142 can be adapted during the execution of the respective sequence control component 131 in an event-dependent manner or as a function of an administrator intervention. Furthermore, if the access to the security-critical resources 101, 102, 103 is rejected, an adaptation of the specifications 212, 222 (step 10) and a renewed evaluation (step 2) of the configuration information 211, 221 can be effected by the management component 113 as a rule. If an access is rejected, then it is alternatively possible to create a corresponding log entry and terminate the respective control application, particularly if the control application attempts to misuse its privileges.

As an alternative to the management component 113 deriving the security policies 142, the security policies 142 can also be derived by the respective additional sequence control component 132 from the specification 212, 222 of the required security-critical resources 101-103. This is particularly possible if use is made exclusively of preinstalled cryptographically protected additional sequence control components 132.

Furthermore, the additional sequence control components 132 can be used for monitoring, in particular logging, whether the access to the currently required security-critical resources 101, 102, 103 is requested or provided in compliance with a security policy 115, 142 that must be applied for the respective sequence control component 131 or for a respective host 100. In accordance with a further exemplary embodiment, in a learning mode, the additional sequence control components 132 can log those resources to which access is requested. It is possible in this way to establish a security policy 142 that is used operationally after the learning mode is complete.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for providing control applications which are each provided via sequence control components which are loadable into a sequence control environment formed by a server entity and executed therein, the method comprising:
establishing a specification of required security-critical resources for each control application whose execution demands selected privileges;
determining an additional sequence control component based on each of the specifications and utilizing the determined additional sequence control component to provide access to the required security-critical resources;
loading the determined the additional sequence control component into the sequence control environment;
commencing executing of a respective sequence control component and the additional sequence control component;
setting up an interface for interprocess communication between the respective sequence control component and the additional sequence control component via the respective sequence control environment;
providing access to a currently required security-critical resources via the interprocess communication between the respective sequence control component and the additional sequence control component; and
establishing each of the specifications as part of configuration information for the respective sequence control component;
wherein the configuration information comprises in each case at least a designation of a memory image for the respective sequence control component and application-specific entries; the configuration information being utilized to at least one of load and execute the respective sequence control component.

14. The method as claimed in claim 13, wherein the configuration information for the sequence control components is extended based on each respective specification.

15. The method as claimed in claim 13, wherein the configuration information is evaluated by a management component assigned to the sequence control environment and is extended in according with the specifications;
wherein the sequence control environment only accepts extensions to the configuration information that are made by the management component; and
wherein configuration information which has been extended in a different manner is rejected by the sequence control environment.

16. The method as claimed in claim 14, wherein the configuration information is evaluated by a management component assigned to the sequence control environment and is extended in according with the specifications;
wherein the sequence control environment only accepts extensions to the configuration information that are made by the management component; and
wherein configuration information which has been extended in a different manner is rejected by the sequence control environment.

17. The method as claimed in claim 15, wherein the specifications of the required security-critical resources are each checked by the management component against a device-specific security policy; and wherein the configuration information for the respective sequence control component is adapted by the management component as a function of a check result.

18. The method as claimed in claim 13, wherein the additional sequence control component at least one of monitors and controls the access by the respective sequence control component to the security-critical resources which that are each required, with reference to a security policy which must be applied for the respective sequence control component.

19. The method as claimed in claim 18, wherein the security policy is derived by one of the additional sequence control component and a management component assigned to the sequence control environment from the specification each of the required security-critical resources.

20. The method as claimed in claim 18, wherein the security policy is adapted during the execution of the respective sequence control component at least one of in an event-dependent manner and as a function of an administrator intervention.

21. The method as claimed in claim 19, wherein the security policy is adapted during the execution of the respective sequence control component at least one of in an event-dependent manner and as a function of an administrator intervention.

22. The method as claimed in claim 13, wherein a plurality of additional sequence control components are preinstalled on a host on whose operating system the sequence control environment is installed.

23. The method as claimed in claim 22, wherein the interface for interprocess communication between the respective sequence control component and the additional sequence control component is provided by the operating system of the host; and wherein the additional sequence control component accesses the security-critical resources which are required for the respective sequence control component via a host interprocess communication interface.

24. The method as claimed in claim 13, wherein the additional sequence control component monitors whether the access to the currently required security-critical resources is at least one of requested and provided in compliance with a security policy which must be applied for at least one of the respective sequence control component and a respective host.

25. The method as claimed in claim 13, wherein the sequence control components are software containers; and wherein the sequence control environment is a container runtime environment.

26. A system for providing control applications, comprising:
a sequence control environment which is formed by a server entity;
at least one sequence control component for providing a control application, the at least one sequence control component being loadable into the sequence control environment and executed therein;
wherein the system is configured such that each specification of required security-critical resources is established for control applications whose execution demands selected privileges and configured such that, based on the specifications, an additional sequence control component is determined in each case to provide access to the required security-critical resources;
wherein the specifications are each established as part of configuration information which each comprise at least a designation of a memory image for the respective sequence control component and application-specific entries and are each utilized to at least one of load and execute the respective sequence control component for the respective sequence control component;
wherein the sequence control environment is configured such that the determined additional sequence control component is loaded into the sequence control environment, such that execution of both the respective sequence control component and the additional sequence control component is started, and such that an interface for interprocess communication between the respective sequence control component and the additional sequence control component is set up; and
wherein the system is further configured such that the access to the currently required security-critical resources is provided via interprocess communication between the respective sequence control component and the additional sequence control component.
